(19) United States
(12) Patent Application Publication
(10) Pub. No.: US 2025/0002017 A1
(43) Pub. Date: Jan. 2, 2025

(54) VEHICLE CONTROL DEVICE AND CONTROL METHOD

(71) Applicant: HONDA MOTOR CO., LTD., Tokyo (JP)

(72) Inventors: Kazuki TOMIOKA, Tokyo (JP); Yoshimitsu MURAHASHI, Tokyo (JP)

(73) Assignee: HONDA MOTOR CO., LTD., Tokyo (JP)

(21) Appl. No.: 18/743,838

(22) Filed: Jun. 14, 2024

(30) Foreign Application Priority Data
Jun. 28, 2023 (JP) 2023-105873

(51) Int. Cl. B60W 30/16; B60W 50/10; G06V 20/59

(52) U.S. Cl. CPC B60W 30/162; B60W 50/10; G06V 20/597; B60W 2420/403; B60W 2540/12; B60W 2540/229; B60W 2554/804

(57) ABSTRACT

A vehicle control device is configured to execute travel control of controlling a vehicle such that the vehicle travels at a target speed corresponding to an inter-vehicle distance between a preceding vehicle that travels in front of the vehicle and the vehicle, or a predetermined speed set by a driver of the vehicle. The vehicle control device is configured to temporarily stop the travel control in response to the driver applying a brake of the vehicle, and to restart the travel control in response to the driver releasing the brake in the vehicle during travel by the travel control, and the vehicle control device includes a control circuit that does not restart the travel control, when the brake is released in a case where a predetermined condition is satisfied.

### CROSS-REFERENCE TO RELATED APPLICATIONS

This application is based on and claims priority under 35 USC 119 from Japanese Patent Application No. 2023-105873 filed on Jun. 28, 2023, the contents of which are incorporated herein by reference.

### TECHNICAL FIELD

The present disclosure relates to a vehicle control device and a control method.

### BACKGROUND

In recent years, attempts have been made to provide access to a sustainable transportation system in consideration of vulnerable traffic participants. As one of the attempts, research and development on driving support technique and automated driving technique of a moving object (for example, a vehicle such as an automobile) have been performed in order to improve safety and convenience of traffic.

For example, Japanese Unexamined Patent Application Publication No. 2005-001566 (hereinafter, referred to as Patent Literature 1) discloses a technique in which adaptive cruise control (ACC) is temporarily stopped when a driver depresses a brake pedal during the ACC, and the ACC is returned from the temporarily stopped state as the driver releases the depression of the brake pedal.

However, in the related art, for example, it is possible that travel control referred to as adaptive cruise control (ACC) may be restarted against an intention of the driver, and there is room for improvement in this regard.

The present disclosure provides a vehicle control device and a control method that can prevent travel control of controlling a vehicle so that a travel speed of the vehicle is a target speed corresponding to an inter-vehicle distance between a preceding vehicle that travels in front of the vehicle and the vehicle or a predetermined speed set by a driver from being restarted against an intention of the driver.

This further improves traffic safety, and contributes to development of a sustainable transportation system.

### SUMMARY

A first aspect of the present disclosure relates to a vehicle control device is configured to execute travel control of controlling a vehicle such that the vehicle travels at a target speed corresponding to an inter-vehicle distance between a preceding vehicle that travels in front of the vehicle and the vehicle, or a predetermined speed set by a driver of the vehicle. The vehicle control device is configured to temporarily stop the travel control in response to the driver applying a brake of the vehicle, and to restart the travel control in response to the driver releasing the brake in the vehicle during travel by the travel control, and the vehicle control device includes a control circuit that does not restart the travel control, when the brake is released in a case where a predetermined condition is satisfied.

A second aspect of the present disclosure relates to a control method performed by a computer. The computer is configured to execute travel control of controlling a vehicle such that the vehicle travels a target speed corresponding to an inter-vehicle distance between a preceding vehicle that travels in front of the vehicle and the vehicle, or a predetermined speed set by a driver of the vehicle. The vehicle control device is configured to temporarily stop the travel control in response to the driver applying a brake of the vehicle, and to restart the travel control in response to the driver releasing the brake in the vehicle during travel by the travel control. The control method includes: performing processing of not restarting the travel control, when the brake is released in a case where a predetermined condition is satisfied.

According to the present invention, it is possible to provide a vehicle control device and a control method that can prevent travel control of controlling a vehicle so that a travel speed of the vehicle is a target speed corresponding to an inter-vehicle distance between a preceding vehicle that travels in front of the vehicle and the vehicle or a predetermined speed set by a driver from being restarted against an intention of the driver.

### BRIEF DESCRIPTION OF DRAWINGS

Exemplary embodiments of the present disclosure will be described in detail based on the following figures, in which:

FIG. 1 is a diagram showing a vehicle 1 controlled by a control device 30 that is an embodiment of a vehicle control device of the present disclosure;

FIG. 2 is a diagram showing an example of an operation of the vehicle 1; and

FIG. 3 is a flowchart showing an example of processing executed by a control device 30.

### DESCRIPTION OF EMBODIMENTS

Hereinafter, an embodiment of a vehicle control device and a control method of the present disclosure will be described in detail with reference to the drawings. The drawings are viewed in directions of reference numerals. The following embodiment does not limit disclosure disclosed in the claims, and not all combinations of features described in the embodiment are necessarily essential for the disclosure. Two or more features among a plurality of features described in the embodiment may be combined freely. Further, in the following description, the same or similar elements are denoted by the same or similar reference numerals, and description thereof may be omitted or simplified appropriately.

### Configuration of Vehicle

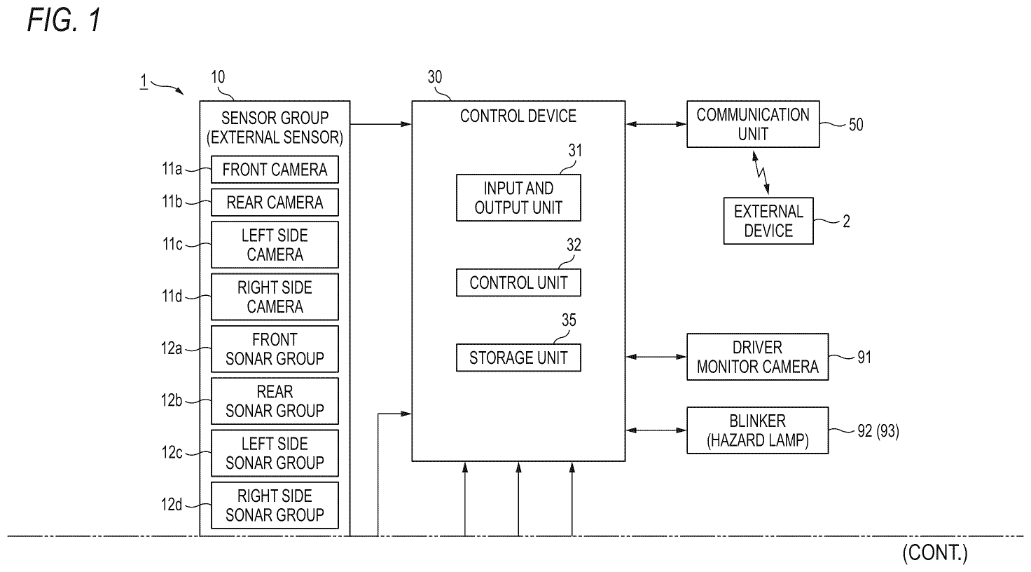

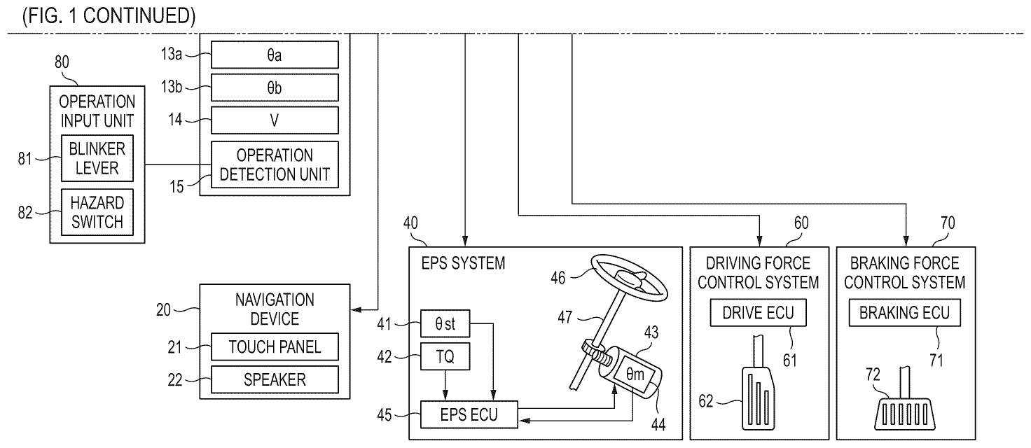

FIG. 1 is a diagram showing a vehicle 1 controlled by a control device 30 that is an embodiment of a vehicle control device of the present disclosure. The vehicle 1 shown in FIG. 1 is an automobile including a drive source, and wheels (all not shown) including drive wheels driven by power of the drive source and driven wheels that can be steered. For example, the vehicle 1 is a four-wheeled automobile including a pair of left and right front wheels and a pair of left and right rear wheels. The drive source of the vehicle 1 may be an electric motor, an internal combustion engine such as a gasoline engine or a diesel engine, or a combination of the electric motor and the internal combustion engine. Further, the drive source of the vehicle 1 may drive the pair of left and right front wheels, the pair of left and right rear wheels, or the four wheels including the pair of left and right front wheels and the pair of left and right rear wheels. Any one of the front wheels and the rear wheels may be driven wheels that can be steered, or both of the front wheels and the rear wheels may be driven wheels that can be steered.

As shown in FIG. 1, the vehicle 1 includes a sensor group 10, a navigation device 20, a control device 30, an EPS system (electric power steering system) 40, a communication unit 50, a driving force control system 60, a braking force control system 70, and an operation input unit 80.

The sensor group 10 obtains various detection values related to the vehicle 1 or a periphery of the vehicle 1. The detection values obtained by the sensor group 10 are sent to the control device 30, and provided for control of the vehicle 1 (for example, ACC to be described later) performed by the control device 30.

The sensor group 10 includes, for example, a front camera 11a, a rear camera 11b, a left side camera 11c, a right side camera 11d, a front sonar group 12a, a rear sonar group 12b, a left side sonar group 12c, and a right side sonar group 12c. The camera group and the sonar group can function as external sensors that obtain peripheral information on the vehicle 1.

The front camera 11a, the rear camera 11b, the left side camera 11c, and the right side camera 11d output image data of the peripheral images obtained by imaging the periphery of the vehicle 1 to the control device 30. The peripheral images captured by the front camera 11a, the rear camera 11b, the left side camera 11c, and the right side camera 11d are also referred to as a front image, a rear image, a left side image, and a right side image. Further, an image constituted by the left side image and the right side image is also referred to as a side image.

The front sonar group 12a, the rear sonar group 12b, the left side sonar group 12c, and the right side sonar group 12d emit sound waves to the periphery of the vehicle 1, and receive reflected sounds from another object. The front sonar group 12a includes, for example, four sonars. The sonars that constitute the front sonar group 12a are provided on an obliquely left front side, a front left side, a front right side, and an obliquely right front side of the vehicle 1. The rear sonar group 12b includes, for example, four sonars. The sonars that constitute the rear sonar group 12b are provided on an obliquely left rear side, a rear left side, a rear right side, and an obliquely right rear side of the vehicle 1. The left side sonar group 12c includes, for example, two sonars. The sonars that constitute the left side sonar group 12c are provided on a left front side and a left rear side of the vehicle 1. The right side sonar group 12d includes, for example, two sonars. The sonars that constitute the right side sonar group 12d are provided on a right front side and a right rear side of the vehicle 1. Instead of or in addition to the sonar groups 12a, 12b, 12c, and 12d, the vehicle 1 may be provided with a radar device that emits radio waves (for example, so-called millimeter radio waves) to the periphery of the vehicle 1 and receives reflected waves from the other object.

The sensor group 10 further includes wheel sensors 13a and 13b, a vehicle speed sensor 14, and an operation detection unit 15. The wheel sensors 13a and 13b detect rotation angles θa and θb of the wheels (not shown). The wheel sensors 13a and 13b may be implemented by angle sensors or displacement sensors. The wheel sensors 13a and 13b output detection pulses every time the wheels are rotated by a predetermined angle. The detection pulses output from the wheel sensors 13a and 13b can be used for calculating a rotation angle of the wheels and a rotation speed of the wheels. A movement distance of the vehicle 1 can be calculated based on the rotation angle of the wheels. The wheel sensor 13a detects, for example, the rotation angle θa of the left rear wheel. The wheel sensor 13b detects, for example, the rotation angle θb of the right rear wheel.

The vehicle speed sensor 14 detects a vehicle speed V that is a travel speed of the vehicle 1, and outputs the detected vehicle speed V to the control device 30. The vehicle speed sensor 14 detects the vehicle speed V based on, for example, rotation of a transmission countershaft.

The operation detection unit 15 detects an operation content of a driver performed using the operation input unit 80, and outputs the detected operation content to the control device 30. The operation input unit 80 includes, for example, a blinker lever 81 that receives an operation of activating a blinker 92 serving as a direction indicator of the vehicle 1, and a hazard switch 82 that receives an operation of activating a hazard lamp 93 of the vehicle 1. The blinker lever 81 can receive, for example, a “right blinker activation operation” that is an operation of activating the right blinker of the blinker 92, and a “left blinker activation operation” that is an operation of activating the left blinker of the blinker 92.

The operation input unit 80 may further include an operation button, an operation switch, or the like that receives an operation related to the ACC, such as an operation of instructing start and end of the ACC and an operation of setting a target speed to be described later. Further, a part (for example, the operation button that receives the operation related to the ACC) or all of the operation input unit 80 may be shared with a touch panel 21 to be described later.

The navigation device 20 identifies a current position of the vehicle 1 by using, for example, a global positioning system (GPS), and guides the driver on a path from the current position of the vehicle 1 to a destination. The navigation device 20 includes, for example, a storage device (not shown) including a map information database.

The navigation device 20 includes a touch panel 21 and a speaker 22. The touch panel 21 is implemented by integrating a display device that can display an image (for example, a liquid crystal display) and an input device that can receive an input of information, and functions as a display device controlled by the control device 30 and an input device that receives an input of various kinds of information to the control device 30. That is, the touch panel 21 can display various screens under control performed by the control device 30, or input various commands received from the driver to the control device 30. Further, the speaker 22 outputs various kinds of guidance by sound under the control performed by the control device 30.

The EPS system 40 includes a steering angle sensor 41, a torque sensor 42, an EPS motor 43, a resolver 44, and an electronic control unit (EPS ECU) 45. The steering angle sensor 41 detects a steering angle θst of a steering 46. The torque sensor 42 detects a torque TQ applied to the steering 46. The EPS motor 43 gives a driving force or a reaction force to a steering column 47 coupled to the steering 46, thereby supporting an operation on the steering 46 (in other words, steering). The resolver 44 detects a rotation angle θm of the EPS motor 43.

The EPS ECU 45 includes, for example, an input and output unit, a calculation unit, and a storage unit (all not shown), and controls the entire EPS system 40. Further, the EPS ECU 45 outputs information indicating the steering angle θst of the steering 46 detected by the steering angle sensor 41 to the control device 30. Further, the EPS ECU 45 may output information indicating a steering speed ω of the steering 46 to the control device 30. The steering speed ω is obtained by, for example, differentiating the steering angle θst with respect to time.

The communication unit 50 is a communication interface that communicates with an external device 2 under the control performed by the control device 30. That is, the control device 30 can communicate with the external device 2 via the communication unit 50. Examples of the external device 2 can include a terminal device (for example, a smartphone) of the driver and a server device managed by a manufacturer of the vehicle 1. For example, a mobile communication network such as a cellular line, Wi-Fi (registered trademark), Bluetooth (registered trademark), or the like can be adopted for the communication between the vehicle 1 and the external device 2.

The driving force control system 60 includes a drive ECU 61, and can control a driving force of the vehicle 1. The drive ECU 61 includes, for example, an input and output unit, a calculation unit, and a storage unit (all not shown), and controls a driving force of the vehicle 1 by controlling the internal combustion engine, the electric motor, or the like that is a drive source of the vehicle 1 based on an operation of the driver on an accelerator pedal 62 provided in the vehicle 1 (hereinafter, also referred to as an “accelerator operation”) or an instruction from the control device 30.

The braking force control system 70 includes a braking ECU 71 and can control a braking force of the vehicle 1. The braking ECU 71 includes, for example, an input and output unit, a calculation unit, and a storage unit (all not shown), and controls a braking force of the vehicle 1 by controlling a brake device (not shown) of the vehicle 1 based on an operation of the driver on a brake pedal 72 provided in the vehicle 1 (hereinafter, also referred to as a “brake operation”) or an instruction from the control device 30. Here, the brake device includes, for example, a brake caliper, a cylinder that transmits hydraulic pressure to the brake caliper, and an electric motor that generates the hydraulic pressure in the cylinder. The braking ECU 71 generates a braking force corresponding to a brake operation by controlling an electric motor of the brake device based on the brake operation or an instruction from the control device 30.

A driver monitor camera 91 is provided inside the vehicle 1, for example, at a position and in a direction where the driver who is an occupant seated in a driver seat of the vehicle 1 can be imaged. The driver monitor camera 91 outputs, to the control device 30, image data of an in-vehicle image obtained by imaging inside of the vehicle 1.

The blinker 92 is a direction indicator implemented by lamps (lamp bodies) or the like provided on a left side (for example, left front and left rear) and a right side (for example, right front and right rear) of the vehicle 1 so as to be visible from outside of the vehicle 1. The blinker 92 is turned on or turned off in response to the operation on the blinker lever 81 described above. Further, the lamps that constitute the blinker 92, that is, the lamps provided on the left side and the right side of the vehicle 1 can also function as the hazard lamp 93 by simultaneously blinking. In the present embodiment, the hazard lamp 93 is implemented by the blinker 92, but the hazard lamp 93 may be implemented by a lamp different from the blinker 92.

### Control Device

The control device 30 is a device (computer) that integrally controls the entire vehicle 1 based on information input from the sensor group 10, the navigation device 20, the EPS system 40, the communication unit 50, the driving force control system 60, the braking force control system 70, and the like.

The control device 30 includes, for example, an input and output unit 31, a control unit 32, and a storage unit 35. The input and output unit 31 is an interface that inputs and outputs data between inside and outside of the control device 30 under control performed by the control unit 32. The storage unit 35 includes, for example, a non-volatile storage medium such as a flash memory, and stores various kinds of information (for example, data and programs) for controlling an operation of the vehicle 1. The control unit 32 is implemented by a processor such as a central processing unit (CPU), and controls constituent elements of the vehicle 1 by executing the programs stored in the storage unit 35 or the like.

In the present embodiment, the control unit 32 can execute “constant speed travel and inter-vehicle distance control” serving as an example of travel control in the present disclosure. The constant speed travel and inter-vehicle distance control is also generally referred to as “adaptive cruise control” (ACC). In the present embodiment, the constant speed travel and inter-vehicle distance control is also referred to as “ACC” hereinafter.

In the ACC, the vehicle 1 is controlled such that the travel speed of the vehicle 1 is a target speed corresponding to an inter-vehicle distance between another vehicle that travels in front of the vehicle 1 (hereinafter, also referred to as a “preceding vehicle”) and the vehicle 1, or a predetermined target speed set by the driver of the vehicle 1. More specifically, the ACC includes “constant speed travel control” of controlling the vehicle 1 such that the travel speed of the vehicle 1 (that is, the vehicle speed V) is the predetermined target speed set by the driver, and “inter-vehicle distance control” of controlling the vehicle 1 such that the inter-vehicle distance between the preceding vehicle and the vehicle 1 is substantially constant. That is, during the ACC, when there is no preceding vehicle, the vehicle 1 is controlled so as to reach the target speed set by the driver, and when there is a preceding vehicle, the vehicle 1 is controlled so as to follow the preceding vehicle while keeping the inter-vehicle distance with the preceding vehicle at a substantially constant value. Further, the target speed in the ACC may be set to a speed corresponding to a travel path on which the vehicle 1 travels. As an example, the control device 30 may recognize a speed sign on a travel path on which the vehicle 1 travels from the peripheral image of the vehicle 1, and set a speed limit indicated by the speed sign as the target speed of the ACC.

For example, the control unit 32 starts the ACC in response to the driver performing an operation of instructing start of the ACC (that is, receiving an operation of instructing the start of the ACC). When the driver applies the brake of the vehicle 1 (for example, when the brake device of the vehicle 1 is applied by performing the brake operation described above) in the vehicle 1 during travel by the ACC, the control unit 32 temporarily stops the ACC and decelerates the vehicle 1. Further, when the brake of the vehicle 1 (for example, the brake operation described above) is released while the ACC is temporarily stopped, the control unit 32 can restart the ACC.

In this way, by adopting a configuration in which the ACC is temporarily stopped and the vehicle 1 is decelerated in response to the driver applying the brake, when decelerating the vehicle 1 during travel by the ACC, the driver can decelerate the vehicle 1 to a desired speed (for example, 0 [km/h]) by only applying the brake. Thereafter, by adopting a configuration in which the ACC can be restarted in response to releasing the brake, when restarting the ACC, the driver can restart the ACC by only simply releasing the brake, and time and effort of the driver can be reduced and convenience can be improved as compared with a case where other operations are also required for restarting the ACC.

Incidentally, when the ACC is necessarily restarted in response to releasing the brake, it is also considered that the ACC may be restarted against an intention of the driver. For example, it is also considered that, after the driver temporarily stops the vehicle 1 that travels by the ACC at a road shoulder or the like, his/her foot may be removed from the brake pedal 72 when luggage placed on a rear seat is taken, whereby the brake may be released. When the ACC may be restarted in such a case, the ACC may be restarted and the vehicle 1 may travel against an intention of the driver who stops the vehicle 1. In this way, it is not preferable from a viewpoint of safety and convenience of the vehicle 1 that the ACC may be restarted against the intention of the driver.

Therefore, when the brake is released in a case where a predetermined condition (hereinafter, also referred to as a “restart prohibition condition”) is satisfied, the control unit 32 prevents the ACC from being restarted when the brake is released. Accordingly, the ACC cannot be restarted in a situation where it is desired that the ACC is prevented from being restarted, while it is possible to allow the ACC to be restarted in other situations. Therefore, the ACC can be appropriately executed, and the safety and the convenience of the vehicle 1 can be improved. The restart prohibition condition is preset in the control device 30 by, for example, the manufacturer of the vehicle 1. Further, the restart prohibition condition may be appropriately changed by the driver.

### Operation of Vehicle

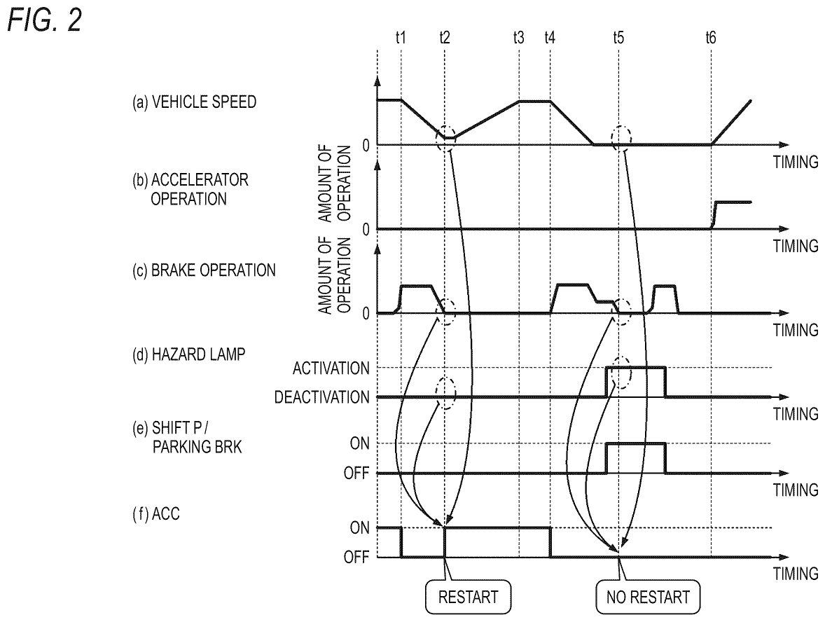

Here, an example of an operation of the vehicle 1 will be described with reference to FIG. 2. The example shown in FIG. 2 is an example of a case where the vehicle 1 being stopped (that is, the vehicle speed V is 0) and the driver activating the hazard lamp 93 of the vehicle 1 when the brake of the vehicle 1 is released are set as the restart prohibition condition of the ACC.

In (a) in FIG. 2, a vertical axis represents the vehicle speed V, and a horizontal axis represents a timing. In (b) in FIG. 2, a vertical axis represents an amount of an operation on the accelerator pedal 62 (that is, the accelerator operation), and a horizontal axis represents a timing. In (c) in FIG. 2, a vertical axis represents an amount of an operation on the brake pedal 72 (that is, the brake operation), and a horizontal axis represents a timing. Further, (d) in FIG. 2 represents activation (for example, turn-on or blinking) and deactivation (for example, turn-off) of the hazard lamp 93 at each timing. (f) in FIG. 2 represents on and off of the ACC at each timing.

As shown in FIG. 2, it is assumed that the brake operation is performed at a timing t1 in the vehicle 1 during travel by the ACC. In this case, since the timing t1, the control device 30 temporarily stops the ACC, generates a braking force corresponding to the brake operation (more specifically, an amount of the operation on the brake pedal 72) via the braking force control system 70, and decelerates the vehicle 1.

At a timing t2 after the timing t1, it is assumed that the brake operation is released (that is, an amount of the operation on the brake pedal 72 is 0). At the timing t2, the vehicle 1 is not stopped (that is, the vehicle speed V>0), and the hazard lamp 93 is also not activated. In such a case, the restart prohibition condition of the ACC is not satisfied at the timing t2. Therefore, in such a case, the control device 30 restarts the ACC since the timing t2. That is, the control device 30 accelerates the vehicle 1 since the timing t2 such that, for example, the vehicle speed V is a predetermined target speed. In the example shown in FIG. 2, at a timing t3 after the timing t2, the vehicle speed V reaches the target speed.

Thereafter, it is assumed that the brake operation is performed again at a timing t4 in the vehicle 1 during travel by the ACC. In this case, since the timing t4, the control device 30 temporarily stops the ACC, generates a braking force corresponding to the brake operation via the braking force control system 70, and decelerates the vehicle 1.

It is assumed that the brake operation is released at a timing t5 after the timing t4. At the timing t5, unlike the timing t2 described above, the vehicle 1 is stopped (that is, the vehicle speed V is 0), and the hazard lamp 93 is also activated. In such a case, the restart prohibition condition of the ACC is satisfied at the timing t5. Therefore, in such a case, the control device 30 does not restart the ACC even if the brake operation is released.

When the accelerator operation is performed at a timing t6 after the timing t5, the control device 30 generates a driving force corresponding to the accelerator operation (more specifically, an amount of the operation on the accelerator pedal 62) via the driving force control system 60, and accelerates the vehicle 1.

As described above, the vehicle 1 being stopped and the hazard lamp 93 being activated when the brake is released are set as the restart prohibition condition of the ACC, and the ACC is prevented from being restarted when such a restart prohibition condition holds, so that the ACC can be prevented from being restarted against an intention of the driver who desires to park or stop the vehicle 1.

In other words, for example, when the brake is released in a case where the hazard lamp 93 is not activated even if the vehicle 1 is stopped, the control device 30 can restart the ACC. Accordingly, for example, it is possible to restart the ACC as the vehicle 1 that has been stopped at an intersection or the like is started, and the convenience of the vehicle 1 can be improved. Further, how the vehicle 1 is accelerated when the ACC is restarted (for example, acceleration when the ACC is restarted) is preset in the control device 30 by, for example, the manufacturer of the vehicle 1, so that rapid acceleration or the like unintended by the driver is not performed when the ACC is restarted as described above.

For example, when the brake is released in a case where the vehicle 1 is not stopped even if the hazard lamp 93 is activated, the control device 30 can also restart the ACC. Accordingly, for example, even if “turning on the hazard lamp 93 indicating gratitude to a following vehicle that gives way when changing a lane or merging” performed customarily in Japan is performed, the ACC can be restarted, and the convenience of the vehicle 1 can be improved.

As shown in (e) in FIG. 2, the restart prohibition condition may further include a shift position of the vehicle 1 being “parking” (shown as “shift P ON” in FIG. 2) or a parking brake (not shown) of the vehicle 1 being applied (shown as “parking BRK ON” in FIG. 2). In this way, it is possible to perform control of the vehicle 1 that more accurately reflects an intention of the driver who desires to park or stop the vehicle 1.

### Processing Performed by Control Device

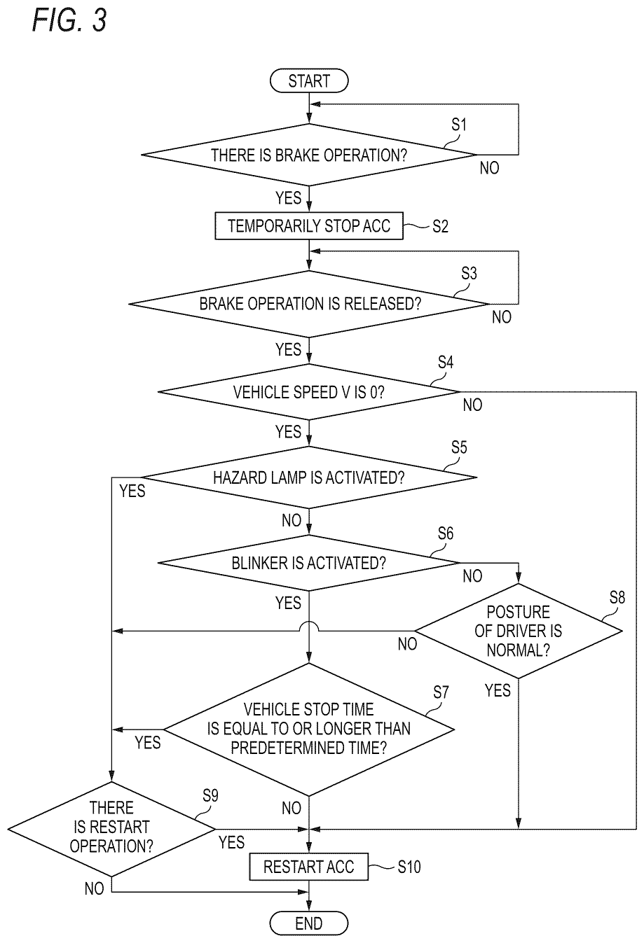

Next, an example of processing executed by the control device 30 will be described with reference to FIG. 3. For example, when the ACC is started in response to receiving an operation of instructing start of the ACC, or the temporarily stopped ACC is restarted, the control device 30 executes the processing shown in FIG. 3.

As shown in FIG. 3, the control device 30 first determines whether there is a brake operation of the driver (step S1). When it is determined that there is no brake operation (step S1: NO), the control device 30 repeats the processing in step S1 until there is the brake operation. Then, when it is determined that there is the brake operation (step S1: YES), the control device 30 temporarily stops the ACC (step S2), and generates a braking force corresponding to the brake operation by the brake device to decelerate the vehicle 1.

When the ACC is temporarily stopped, the control device 30 may notify the driver that the ACC is temporarily stopped or that the ACC can be restarted via, for example, the touch panel 21 or the speaker 22. In this way, it is possible to prevent the driver from performing an unnecessary operation and to reduce time and effort of the driver.

Next, the control device 30 determines whether the brake operation of the driver is released (step S3). When it is determined that the brake operation is not released (step S3: NO), the control device 30 repeats the processing in step S3 until the brake operation is released. Then, when it is determined that the brake operation is released (step S3: YES), the control device 30 determines whether the vehicle speed V is 0, that is, whether the vehicle 1 is stopped (step S4).

When it is determined that the vehicle speed V is not 0, that is, the vehicle 1 is not stopped (step S4: NO), the control device 30 determines that the restart prohibition condition of the ACC is not satisfied, and restarts the ACC (step S10). When the ACC is restarted by the processing in step S10, the control device 30 executes the processing shown in FIG. 3 again.

When it is determined that the vehicle speed V is 0, that is, the vehicle 1 is stopped (step S4: YES), the control device 30 determines whether the hazard lamp 93 is activated (step S5). Then, when it is determined that the hazard lamp 93 is not activated (step S5: NO), the control device 30 determines whether the blinker 92 is activated (step S6).

When it is determined that the blinker 92 is activated (step S6: YES), the control device 30 determines whether a current vehicle stop time (namely, a time period during which the vehicle 1 is stopped) is equal to or longer than a predetermined time (for example, 5 [min]) (step S7). Here, the current vehicle stop time can be set as, for example, an elapsed time since the vehicle 1 is stopped most currently until now.

When the processing in step S7 is performed, the control device 30 may obtain, for example, a time at which the peripheral image captured by the cameras (the front camera 11a and the like) that constitute the sensor group 10 is not substantially changed as the vehicle stop time, or a time at which the vehicle speed V detected by the vehicle speed sensor 14 is 0 as the vehicle stop time.

When it is determined that the vehicle stop time is less than the predetermined time (step S7: NO), the control device 30 determines that the restart prohibition condition of the ACC is not satisfied, proceeds to the processing in step S10 described above, and restarts the ACC. That is, when the blinker 92 is activated and the vehicle stop time is less than the predetermined time, it is considered that the vehicle 1 is merely stopped waiting for a left or right turn and that the driver has no intention of parking or stopping the vehicle. Therefore, in such a case, when the ACC is restarted in response to releasing the brake operation, there is no need for the driver to separately perform the operation of instructing the start of the ACC, and the convenience can be improved.

When it is determined that the blinker 92 is not activated (step S6: NO), the control device 30 determines whether a posture of the driver is normal (step S8). In the processing in step S8, for example, when it is detected that the driver does not face a traveling direction of the vehicle 1 or that the driver does not grip the steering 46 based on an analysis result of an in-vehicle image captured by the driver monitor camera 91, the control device 30 determines that the posture of the driver is not normal. On the other hand, when it is detected that the driver faces the traveling direction of the vehicle 1 and grips the steering 46, the control device 30 determines that the posture of the driver is normal.

When it is determined that the posture of the driver is normal (step S7: YES), the control device 30 determines that the restart prohibition condition of the ACC is not satisfied, proceeds to the processing in step S10 described above, and restarts the ACC. That is, when the posture of the driver is normal, in other words, when the driver takes a posture suitable for driving the vehicle 1, it is considered that the driver has no intention of parking or stopping the vehicle. Therefore, in such a case, when the ACC is restarted in response to releasing the brake operation, for example, it is possible to restart the ACC as the vehicle 1 that has been stopped at an intersection or the like is started, there is no need for the driver to separately perform the operation of instructing the start of the ACC, and the convenience can be improved.

On the other hand, when it is determined that the hazard lamp 93 is activated (step S5: YES), when it is determined that the blinker 92 is activated and the vehicle stop time is equal to or longer than the predetermined time (step S6: YES, step S7: YES), or when it is determined that the posture of the driver is not normal (step S8: NO), the control device 30 determines that the restart prohibition condition of the ACC is satisfied and does not restart the ACC. Then, the control device 30 proceeds to processing in step S9.

Next, the control device 30 determines whether there is a restart operation of instructing the restart of the ACC (step S9). Here, the restart operation can be, for example, at least one operation that can be performed when the vehicle 1 is started, such as an operation of deactivating the hazard lamp 93, an operation of deactivating the blinker 92, an operation of activating the blinker 92 on a side opposite to a road shoulder, or the accelerator operation.

When it is determined that there is no restart operation (step S9: NO), the control device 30 does not restart the ACC, and ends the processing shown in FIG. 3 as it is. On the other hand, when it is determined that there is the restart operation (step S9: YES), the control device 30 proceeds to the processing in step S10 described above, and restarts the ACC.

As described above, after the control device 30 (for example, the control unit 32) temporarily stops the ACC in response to the driver applying the brake of the vehicle 1 in the vehicle 1 during travel by the ACC, when the brake is released in a case where the restart prohibition condition of the ACC is satisfied, the control device 30 (for example, the control unit 32) prevents the ACC from being restarted. Accordingly, the ACC can be prevented from being restarted against an intention of the driver who desires to park or stop the vehicle 1.

More specifically, for example, when the brake operation is released in a case where the vehicle 1 is stopped and the hazard lamp 93 is activated, the control device 30 determines that the restart prohibition condition of the ACC is satisfied, and prevents the ACC from being restarted. That is, when the vehicle 1 is stopped and the hazard lamp 93 is activated, it is considered that the driver has an intention to park or stop the vehicle 1. Therefore, when the brake operation is released in a case where the vehicle 1 is stopped and the hazard lamp 93 is activated, the control device 30 prevents the ACC from being restarted, so that the ACC can be prevented from being restarted against an intention of the driver who desires to park or stop the vehicle 1.

For example, when the brake operation is released in a case where the vehicle 1 is stopped and the posture of the driver is not normal, the control device 30 determines that the restart prohibition condition of the ACC is satisfied, and prevents the ACC from being restarted. That is, it is not preferable from a viewpoint of safety to start travel of the vehicle 1 even though the posture of the driver is not normal. Therefore, when the vehicle 1 is stopped and the posture of the driver of the vehicle 1 is not normal, the control device 30 prevents the ACC from being restarted, so that the ACC can be prevented from being restarted when the driver does not have preparation for causing the vehicle 1 to travel.

For example, when the brake operation is released in a case where the vehicle 1 is stopped, the blinker 92 is activated, and a current vehicle stop time is equal to or longer than the predetermined time, the control device 30 determines that the restart prohibition condition of the ACC is satisfied, and prevents the ACC from being restarted. That is, when the vehicle 1 is stopped for the predetermined time or more in a state where the blinker 92 is activated, it is highly possible that the vehicle 1 is parked or stopped at a road shoulder or the like. Therefore, when the vehicle 1 is stopped, the blinker 92 is activated, and the current vehicle stop time is equal to or longer than the predetermined time, the control device 30 prevents the ACC from being restarted, so that the ACC can be prevented from being restarted against an intention of the driver in the parked or stopped vehicle 1. On the other hand, when the vehicle 1 is stopped for a short time (in other words, less than the predetermined time) in a state where the blinker 92 is activated, it is highly possible that the vehicle 1 is temporarily stopped waiting for a left or right turn of an intersection. In such a case, the control device 30 can automatedly restart the ACC, and can improve the convenience.

The control device 30 obtains a vehicle stop time based on, for example, a detection result of the vehicle speed sensor 14 and/or images captured by the cameras (for example, the front camera 11a, the rear camera 11b, the left side camera 11c, and the right side camera 11d) that can image periphery of the vehicle 1, and determines whether the vehicle stop time is equal to or longer than the predetermined time. Accordingly, even if the vehicle 1 is stopped without activating the hazard lamp 93 or the blinker 92, it is possible to accurately obtain the vehicle stop time.

For example, even if the ACC can be prevented from being restarted, in a case where the brake operation is released and there is the restart operation for starting the vehicle 1, the control device 30 restarts the ACC. Accordingly, when the driver performs an operation for starting the vehicle 1, since the ACC can be restarted, as compared with a case where a dedicated operation is required to restart the ACC, the ACC can be restarted while reducing time and effort of the driver.

For example, when the ACC is temporarily stopped, the control device 30 notifies the driver that the ACC is temporarily stopped or that the ACC can be restarted. Accordingly, when the ACC is temporarily stopped, it is possible to prevent the driver from performing an unnecessary operation to restart the ACC, and to reduce the time and effort of the driver.

A control method described in the present embodiment can be implemented by a computer executing a program prepared in advance. The present program is stored in a computer-readable storage medium, and is executed by being read from the storage medium. Further, the present program may be provided in a form of being stored in a non-volatile (non-transitory) storage medium such as a flash memory, or may be provided via a network such as the Internet. The computer that executes the present program may be provided in the vehicle 1, or may be provided in the external device 2 (for example, a server device) that can communicate with the vehicle 1.

Although one embodiment of the present disclosure has been described, it goes without saying that the present disclosure is not limited to this embodiment. It is apparent that those skilled in the art can conceive of various modifications and alterations within the scope described in the claims, and it is understood that such modifications and alterations naturally fall within the technical scope of the present disclosure. Further, the constituent elements in the embodiment described above may be combined freely in a scope not departing from the gist of the disclosure.

For example, in the embodiment described above, the ACC is prevented from being restarted when the brake is released in a case where the blinker 92 is activated and the current vehicle stop time is equal to or longer than the predetermined time, but the present disclosure is not limited thereto. For example, even if the blinker 92 or the hazard lamp 93 is not activated when the brake is released, the ACC may be prevented from being restarted if the current vehicle stop time is equal to or longer than the predetermined time.

That is, when the vehicle 1 is stopped for a long time, it is highly possible that the vehicle 1 is parked or stopped. Therefore, when the vehicle 1 is stopped for the predetermined time or more without releasing the brake operation, the ACC may be prevented from being restarted regardless of whether the blinker 92 or the hazard lamp 93 is activated. Even in this case, the ACC can be prevented from being restarted against an intention of the driver in the parked or stopped vehicle 1.

In a case where the vehicle 1 is stopped and it is recognized that the driver who drives the vehicle 1 performs an action unrelated to driving of the vehicle 1 based on an image captured by the driver monitor camera 91 when the brake of the vehicle 1 is released, the control device 30 may prevent the ACC from being restarted when the brake is released. For example, it is not preferable from a viewpoint of safety to start travel of the vehicle 1 even though the driver performs an action unrelated to driving of the vehicle 1 such as an operation on a smartphone. Therefore, in a case where the vehicle 1 is stopped and it is recognized that the driver performs an action unrelated to driving of the vehicle 1, the control device 30 prevents the ACC from being restarted when the brake is released, so that the ACC can be prevented from being restarted when the driver does not have preparation for causing the vehicle 1 to travel. Further, when the vehicle 1 is stopped for the predetermined time or more in combination with the determination using the vehicle stop time described above, and it is recognized that the driver performs an action unrelated to driving of the vehicle 1, the control device 30 determines that the driver has an intention to park or stop the vehicle 1, and may prevent the ACC from being restarted even if the brake of the vehicle 1 is released.

In the embodiment described above, a four-wheeled automobile is exemplified as the vehicle, but the present disclosure is not limited thereto. A vehicle to which the technique of the present disclosure can be applied may be a two-wheeled automobile (so-called motorcycle).

In the embodiment described above, an example in which the travel control in the present disclosure is the ACC has been described, but the present disclosure is not limited thereto. For example, the travel control in the present disclosure may be constant speed travel control not including the inter-vehicle distance control (cruise control).

In the present specification, at least the following matters are described. Although corresponding constituent elements or the like in the embodiment described above are shown in parentheses, the present disclosure is not limited thereto.

(1) A vehicle control device (the control device 30), in which

the vehicle control device is configured to execute travel control of controlling a vehicle (the vehicle 1) such that the vehicle travels at a target speed corresponding to an inter-vehicle distance between a preceding vehicle that travels in front of the vehicle and the vehicle, or a predetermined speed set by a driver of the vehicle,

the vehicle control device is configured to temporarily stop the travel control in response to the driver applying a brake (the braking force control system 70) of the vehicle, and to restart the travel control in response to the driver releasing the brake in the vehicle during travel by the travel control, and

the vehicle control device includes a control circuit (the control unit 32) that does not restart the travel control, when the brake is released in a case where a predetermined condition is satisfied.

According to (1), in a case where the predetermined condition is satisfied when the brake is released, since the travel control is not restarted, it is possible to prevent the travel control from being restarted in a situation where it is desired to prevent the travel control from being restarted, while allowing the travel control to be restarted in other situations. Therefore, the travel control can be appropriately executed, and safety and convenience of the vehicle can be improved, which can further improve traffic safety and contribute to development of a sustainable transportation system.

(2) The vehicle control device according to (1), in which

the control circuit does not restart the travel control, when the brake is released in a case where the vehicle is stopped and the driver activates a hazard lamp (the hazard lamp 93) of the vehicle.

When the vehicle is stopped and the hazard lamp is activated (for example, turned on), it is considered that the driver has an intention to park or stop the vehicle. According to (2), in a case where the vehicle is stopped and the driver activates the hazard lamp of the vehicle when the brake of the vehicle is released, since the travel control is not restarted, the travel control can be prevented from being restarted against an intention of the driver who desires to park or stop the vehicle.

(3) The vehicle control device according to (1), in which

the control circuit does not restart the travel control, when the brake is released in a case where the vehicle is stopped and a posture of the driver is not normal.

It is not preferable from a viewpoint of safety to start travel of the vehicle even though the posture of the driver is not normal. According to (3), in a case where the vehicle is stopped and the posture of the driver is not normal when the brake of the vehicle is released, since the travel control is not restarted, the travel control can be prevented from being restarted when the driver does not have preparation for causing the vehicle to travel.

(4) The vehicle control device according to (1), in which

the vehicle includes a driver monitor camera (the driver monitor camera 91) configured to image the driver, and

the control circuit does not restart the travel control, when the brake is released in a case where the vehicle is stopped and it is recognized based on an image captured by the driver monitor camera that the driver performs an action unrelated to driving of the vehicle.

It is not preferable from a viewpoint of safety to start travel of the vehicle even though the driver performs the action unrelated to the driving of the vehicle. According to (4), in a case where the vehicle is stopped and it is recognized that the driver performs the action unrelated to the driving of the vehicle when the brake of the vehicle is released, since the travel control is not restarted, the travel control can be prevented from being restarted when the driver does not have preparation for causing the vehicle to travel.

(5) The vehicle control device according to (1), in which

the control circuit does not restart the travel control, when the brake is released in a case where the vehicle is stopped, the driver activates a blinker of the vehicle, and a time period during which the vehicle is stopped is equal to or longer than a predetermined time.

When the vehicle is stopped for the predetermined time or more in a state where the blinker is activated (for example, turned on), it is highly possible that the vehicle is parked or stopped at a road shoulder or the like. According to (5), in a case where the vehicle is stopped, the driver activates the blinker, and the current vehicle stop time is equal to or longer than the predetermined time when the brake of the vehicle is released, since the travel control is not restarted, the travel control can be prevented from being restarted against an intention of the driver in the parked or stopped vehicle. On the other hand, when the vehicle is stopped only for a short time (in other words, less than the predetermined time) in a state where the driver activates the blinker, it is highly possible that the vehicle is temporarily stopped waiting for a left or right turn of an intersection. According to (5), in such a case, the travel control can be automatedly restarted in response to releasing the brake of the vehicle, and convenience can be improved.

(6) The vehicle control device according to (1), in which

the control circuit does not restart the travel control, when the brake is released in a case where the vehicle is stopped and a time period during which the vehicle is stopped is equal to or longer than a predetermined time, and

the control circuit determines whether the time period is equal to or longer than the predetermined time based on a detection result of a vehicle speed sensor configured to detect a travel speed of the vehicle and/or an image captured by a camera configured to image a periphery of the vehicle.

According to (6), even if the vehicle is stopped without activating the hazard lamp or the blinker, it is possible to accurately obtain the vehicle stop time.

(7) The vehicle control device according to any one of (1) to (6), in which

the control circuit further notifies the driver that the travel control is temporarily stopped or that the travel control is restartable, when the travel control is temporarily stopped.

According to (7), when the travel control is temporarily stopped, it is possible to prevent the driver from performing an unnecessary operation to restart the travel control, and to reduce time and effort of the driver.

(8) The vehicle control device according to any one of (1) to (6), in which

the control circuit restarts the travel control in response to the brake being released and the driver performing a predetermined restart operation, and

the restart operation is an operation for starting traveling.

According to (8), when the driver performs the operation for starting the vehicle, since the travel control can be restarted, as compared with a case where a dedicated operation is required to restart the travel control, the travel control can be restarted while reducing the time and effort of the driver.

(9) A control method performed by a computer (the control device 30), in which

the computer is configured to execute travel control of controlling a vehicle (the vehicle 1) such that the vehicle travels a target speed corresponding to an inter-vehicle distance between a preceding vehicle that travels in front of the vehicle and the vehicle, or a predetermined speed set by a driver of the vehicle,

the vehicle control device is configured to temporarily stop the travel control in response to the driver applying a brake (the braking force control system 70) of the vehicle, and to restart the travel control in response to the driver releasing the brake in the vehicle during travel by the travel control, the control method including:

performing processing of not restarting the travel control, when the brake is released in a case where a predetermined condition is satisfied.

According to (9), in a case where the predetermined condition is satisfied when the brake is released, since the travel control is not restarted, it is possible to prevent the travel control from being restarted in a situation where it is desired to prevent the travel control from being restarted, while allowing the travel control to be restarted in other situations. Therefore, the travel control can be appropriately executed, and safety and convenience of the vehicle can be improved, which can further improve traffic safety and contribute to development of a sustainable transportation system.

1. A vehicle control device, wherein
the vehicle control device is configured to execute travel control of controlling a vehicle such that the vehicle travels at a target speed corresponding to an inter-vehicle distance between a preceding vehicle that travels in front of the vehicle and the vehicle, or a predetermined speed set by a driver of the vehicle,
the vehicle control device is configured to temporarily stop the travel control in response to the driver applying a brake of the vehicle, and to restart the travel control in response to the driver releasing the brake in the vehicle during travel by the travel control, and
the vehicle control device includes a control circuit that does not restart the travel control, when the brake is released in a case where a predetermined condition is satisfied.

2. The vehicle control device according to claim 1, wherein
the control circuit does not restart the travel control, when the brake is released in a case where the vehicle is stopped and the driver activates a hazard lamp of the vehicle.

3. The vehicle control device according to claim 1, wherein
the control circuit does not restart the travel control, when the brake is released in a case where the vehicle is stopped and a posture of the driver is not normal.

4. The vehicle control device according to claim 1, wherein
the vehicle includes a driver monitor camera configured to image the driver, and
the control circuit does not restart the travel control, when the brake is released in a case where the vehicle is stopped and it is recognized based on an image captured by the driver monitor camera that the driver performs an action unrelated to driving of the vehicle.

5. The vehicle control device according to claim 1, wherein
the control circuit does not restart the travel control, when the brake is released in a case where the vehicle is stopped, the driver activates a blinker of the vehicle, and a time period during which the vehicle is stopped is equal to or longer than a predetermined time.

6. The vehicle control device according to claim 1, wherein
the control circuit does not restart the travel control, when the brake is released in a case where the vehicle is stopped and a time period during which the vehicle is stopped is equal to or longer than a predetermined time, and
the control circuit determines whether the time period is equal to or longer than the predetermined time based on a detection result of a vehicle speed sensor configured to detect a travel speed of the vehicle and/or an image captured by a camera configured to image a periphery of the vehicle.

7. The vehicle control device according to claim 1, wherein
the control circuit further notifies the driver that the travel control is temporarily stopped or that the travel control is restartable, when the travel control is temporarily stopped.

8. The vehicle control device according to claim 1, wherein
the control circuit restarts the travel control in response to the brake being released and the driver performing a predetermined restart operation, and
the restart operation is an operation for starting traveling.

9. A control method performed by a computer, wherein
the computer is configured to execute travel control of controlling a vehicle such that the vehicle travels a target speed corresponding to an inter-vehicle distance between a preceding vehicle that travels in front of the vehicle and the vehicle, or a predetermined speed set by a driver of the vehicle,
the vehicle control device is configured to temporarily stop the travel control in response to the driver applying a brake of the vehicle, and to restart the travel control in response to the driver releasing the brake in the vehicle during travel by the travel control, the control method comprising:
performing processing of not restarting the travel control, when the brake is released in a case where a predetermined condition is satisfied.
